(19) United States
(12) Patent Application Publication
(10) Pub. No.: US 2003/0093968 A1
(43) Pub. Date: May 22, 2003

(54) Stratified stone and method of manufacture

(76) Inventor: Roy L. Fox JR., Belleville, WV (US)

Correspondence Address: HENDERSON & STURM LLP, 1213 MIDLAND BUILDING, 206 SIXTH AVENUE, DES MOINES, IA, 50309-4076, US

(21) Appl. No.: 09/988,542

(22) Filed: Nov. 20, 2001

(51) Int. Cl. B32B 3/10

(52) U.S. Cl. 52/612; 52/390; 52/796.1; 428/44

(57) ABSTRACT

An artificial stratified stone construction (10) for producing building components (21) and the method employed in the manufacture of the building components (21). The artificial stratified stone construction (10) includes a slab (20) having a plurality of different colored layers (22) of cured concrete such that the exposed sides of each of the building components (21) will expose the variable stratified color and thickness layers (22) which constitute the finished product.

### CROSS REFERENCE TO RELATED APPLICATIONS

Not applicable.

### BACKGROUND OF THE INVENTION

1. Field of the Invention

The present invention relates to the field of artificial stone fabrication in general and in particular to a process for fabricating a stratified stone building component and the finished product produced thereby.

2. Description of Related Art

As can be seen by reference to the following U.S. Pat. Nos. 5,502,941; 5,735,094; 4,975,303; 4,721,634; 5,398,458; 3,719,512; 5,183,616; and, 3,951,283, the prior art is replete with myriad and diverse artificial stone constructions.

While all of the aforementioned prior art constructions are more than adequate for the basic purpose and function for which they have been specifically designed, they are uniformly deficient with respect to their failure to provide a simple, efficient, and authentically pleasing stratified stone building component wherein the exposed edges on four sides of the building component expose multiple layers of different colored strata.

In many regions, naturally occurring stratified stone is very scarce, and if it is available, the desired color and stratification thickness may not be available.

Despite this fact, naturally stratified stone enjoys widespread usage in the construction trades, at least on a limited basis, due to its natural beauty and universal appeal.

As a consequence of the foregoing situation, there has existed a longstanding need among building contractors, architects and landscapers for a new and improved method of artificially producing large quantities of stratified stone having both relatively uniform and/or widely divergent arrangements of different colored strata for diverse building applications; and, the provision of such a method and the finished product produced thereby is the stated objective of the present invention.

### BRIEF SUMMARY OF THE INVENTION

Briefly stated, the artificial stratified stone that forms the basis of the present invention comprises sequential layers of colored concrete having selected thickness wherein the color of each layer is different and created by either naturally occurring concrete components such as different colored sand or by the addition of pigment to impart a particular color, shading, or hue to the individual layers of concrete.

As will be explained in greater detail further on in the specification, the individual layers of concrete are sequentially deposited into a large relatively shallow rectangular receptacle and allowed to set to create a large cured slab of concrete which is then subjected to a mechanical cutting process to produce smaller rectangular bricks, beams or other building components; wherein, the exposed sides of the particular building component will reveal the multi-colored stratification of the finished product.

In addition, one or more of the layers may be mechanically deformed while uncured and contoured inserts may also be introduced at various stages in the fabrication to produce a non-uniform variable visual effect to the finished product.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a perspective view of the finished product in slab form showing one finished building component removed;

FIG. 2 is an isolated perspective view of a finished building component produced by the method of this invention;

FIG. 3 is a perspective view of one apparatus that can be employed to fabricate the slab phase of the finished product;

FIG. 4 is a perspective view of yet another apparatus that may be employed to fabricate the slab phase of the finished product;

FIG. 5 is a perspective view of still another apparatus that may be employed to fabricate the slab phase of the finished product.

### DETAILED DESCRIPTION OF THE INVENTION

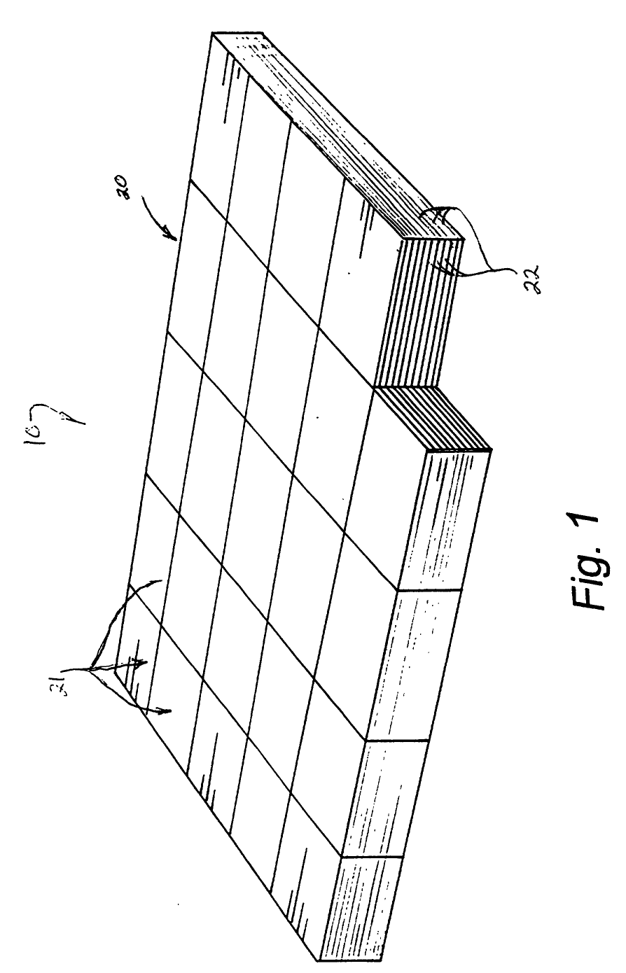

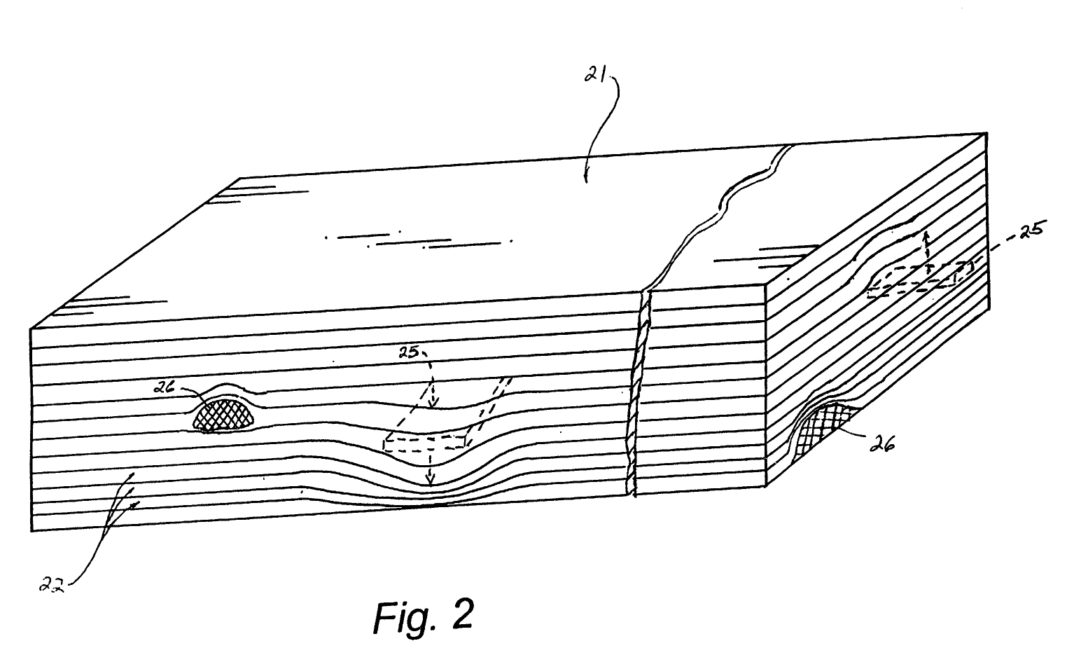

As can be seen by reference to the drawings, and in particular to FIGS. 1 and 2, the artificial stratified stone construction that forms the basis of the present invention is designated generally by the reference number 10. The first phase of the finished construction comprises a cured slab 20 having a plurality of layers 22 of different colored concrete wherein the thickness of the individual layers is generally uniform and ideally the thickness among the various layers is widely divergent to produce an aesthetically pleasing effect as will be explained in greater detail further on in the specification.

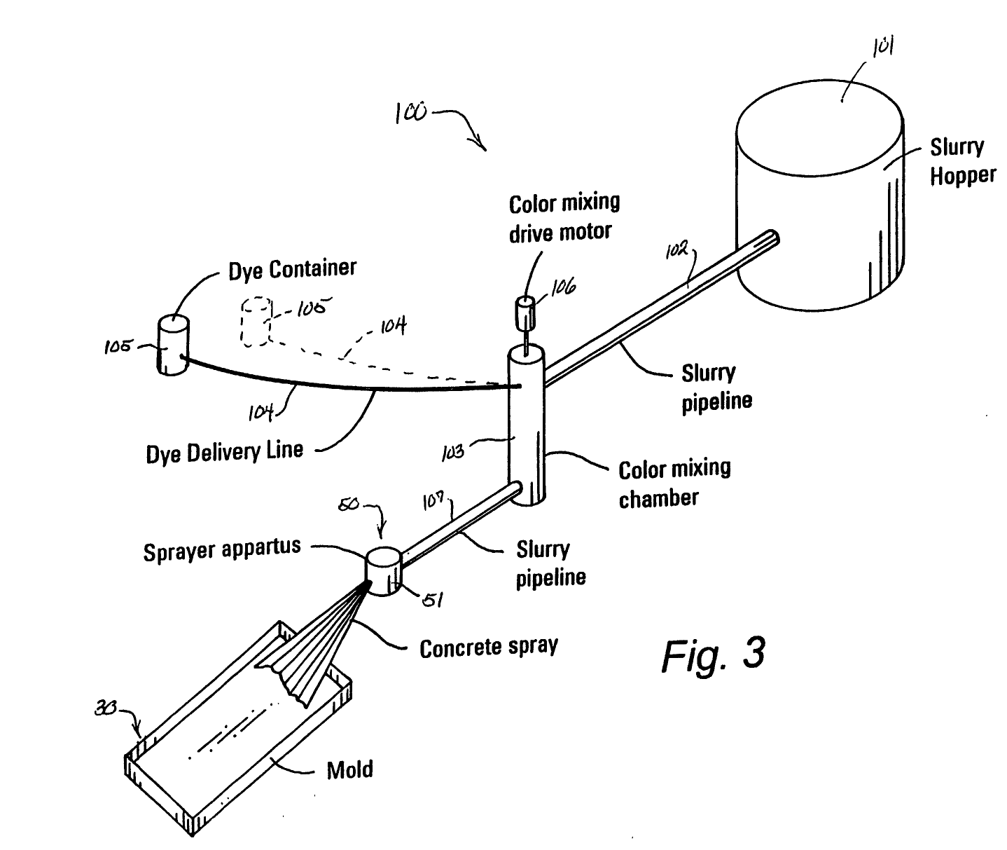

As can best be seen by reference to FIG. 3, the first proposed method for the fabrication of the artificially stratified simulated stone construction 10 involves an enlarged rectangular generally shallow mold 30 that is used to receive and contain the sequential layers 22 of different colored concrete until the concrete cures into the finished slab phase 20.

At this juncture, it should be noted that in the three proposed methods of manufacture, the basic apparatus designated generally as 100 used to prepare the different colored layers of concrete 22 are essentially the same and only the actual delivery mechanisms will vary.

The basic apparatus 100 comprises in general an enlarged capacity slurry hopper reservoir 101 used to mix the basic concrete constituents sand, water, and cement. The liquified concrete mixture is then delivered by a slurry supply pipeline 102 into a reduced capacity color mixing chamber 103 which is provided with a plurality of dye delivery lines 104 wherein each dye delivery line 104 is in turn connected to an individual dye container 105 that will deliver a selected dye pigment to the color mixing chamber 103.

Once the dye has been introduced into the color mixing chamber 103, a color mixing drive motor 106 associated with the color mixing chamber 103 is activated to evenly distribute the dye through the concrete in the color mixing chamber 103 which is then delivered through a colored slurry delivery pipeline 107 to the colored concrete depositing apparatus designated generally as 50.

As shown in FIG. 3, in the first proposed method of fabrication, the concrete depositing apparatus 50 comprises a concrete sprayer apparatus 50 which sprays each colored batch of concrete in a sequential fashion into the slab mold 30 where it will remain until the slab 20 has properly cured.

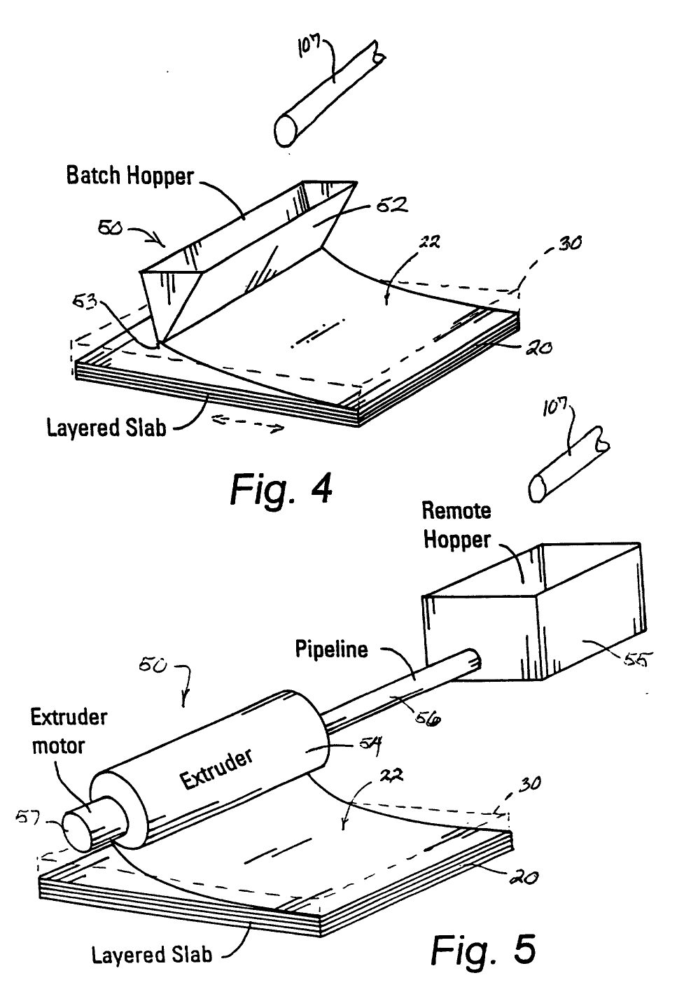

Turning now to FIGS. 4 and 5, it can be seen that in the second proposed method of manufacture, the concrete depositing apparatus 50 comprises a batch hopper 52 wherein the size of the hopper opening 53 determines the thickness of the individual layer of concrete 22 that is deposited into the mold 30 as well as the number of times that the mold 30 is reciprocated beneath the batch hopper 52 by a reciprocating carrier (not shown).

As can be seen in FIG. 5, in the third proposed method of fabrication, the concrete depositing apparatus 50 comprises in general an extruder 54 which is fed from a remote hopper 55 by a pipeline 56 wherein the extruder 54 is provided with a motor 57 for forcing the concrete contents of the extruder 54 into the reciprocating slab mold 30.

Returning once more to FIGS. 1 and 2, it can be seen that once the slab 20 has been properly cured, the top surface of the slab 20 is marked into a grid pattern to identify the general outline of the building components 21 that are to be rendered from the slab 20. In the embodiment depicted in FIG. 1, the grid pattern is intended to produce a plurality of identically shaped bricks 21. However, other building components 21 such as window sills, mantle pieces or the like can be rendered from the slab.

As can also be seen by reference to FIG. 2, the finished building component 21 exposes the multi-layer stratification on all four exposed sides. Furthermore, while the individual layers 22 will normally have a generally uniform thickness, it is also possible to produce dramatic thickness variations at selected portions of adjacent layers.

In order to achieve this effect, a predetermined number of successive layers 22 are allowed to be introduced into the receiving receptacle and then are mechanically deformed by vertically depressing a plurality of the lower layers 22 with an implement 25 prior to adding the succeeding upper layers as depicted on the face of the building component 21 and/or by vertically raising the upper layers 22 with an implement 25 as depicted on the right side of FIG. 2.

By now it should be appreciated that building components 21 fabricated in accordance with the teachings of this invention can produce a wide variety of color and strata thickness combinations that will result in a low cost, aesthetically pleasing, finished building component that is readily susceptible to mass production techniques.

Furthermore, as shown in FIG. 2, this invention also contemplates introducing contoured inserts 26 at any point either prior to the introduction of the first layer of concrete or after some of the successive layers have been introduced into the receiving receptacle which can be randomly dispersed among the layers 22 and whose presence in the individual building components 21 will be revealed once the slab 20 is severed into the individual building components.

Although only exemplary embodiments of the invention have been described in detail above, those skilled in the art will readily appreciate that many modifications are possible without materially departing from the novel teachings and advantages of this invention. Accordingly, all such modifications are intended to be included within the scope of this invention as defined in the following claims.

In the claims, means-plus-function clauses are intended to cover the structures described herein as performing the recited function and not only structural equivalents, but also equivalent structures.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

I claim:

1. An artificial stratified stone construction for providing building components wherein the construction comprises a plurality of vertically arranged layers of different colored cured concrete.

2. The construction as in claim 1; wherein, each of the individual layers has a generally uniform thickness.

3. The construction as in claim 2; wherein, the thickness among different individual layers is varied.

4. The construction as in claim 1; wherein, the individual layers will comprise both uniform thickness layers as well as variable thickness layers.

5. The construction as in claim 4; wherein the variable thickness layers will be disposed adjacent to one another.

6. The construction as in claim 5; wherein, the variable thickness layers will have a uniform thickness portion and a variable thickness portion.

7. The construction as in claim 6; wherein, the various thickness portion on each of the various thickness layers is disposed adjacent to one another.

8. The construction as in claim 4 further including contoured inserts that are interspersed between the layers.

9. A method of forming an artificial stratified stone construction comprising the steps of:
a) introducing a first layer of uncured concrete having a first selected color into a generally shallow enlarged rectangular receiving receptacle;
b) introducing succeeding layers of uncured concrete upon said first layer of uncured concrete wherein said succeeding layers have different colors and each layer of one color is disposed adjacent to a layer of a different color;
c) allowing the layers to cure into a slab;
d) removing the slab from the generally shallow enlarged rectangular receiving receptacle;
e) severing the slab into generally rectangular building components.

10. The method as in claim 9; wherein, each individual layer has a uniform thickness.

11. The method as in claim 10; wherein, the thickness among different individual layers is varied.

12. The method as in claim 9; wherein, the individual layers will comprise both uniform thickness layers as well as variable thickness layers.

13. The method as in claim 12; wherein, the variable thickness layers will be disposed adjacent to one another.

14. The method as in claim 9 further including the intermediate step of
f) mechanically deforming uncured layers with a downward force to create variable thickness cured layers.

15. The method as in claim 9 further including the intermediate step of
g) mechanically deforming uncured layers with an upward force to create variable thickness layers.

16. The method as in claim 14 further including the intermediate step of
g) mechanically deforming uncured layers with an upward force to create variable thickness layers.

17. The method as in claim 9 further including the preliminary step of
h) placing at least one contoured insert into the generally shallow enlarged rectangular receiving receptacle prior to introducing said first layer of uncured concrete into said receiving receptacle.

18. The method as in claim 17 further including the intermediate step of
i) allowing a predetermined number of successive layers to be introduced into the generally shallow enlarged rectangular receiving receptacle;
j) placing at least one contoured insert upon the top layer of the introduced layers; and,
k) introducing the remainder of said successive layers into said receiving receptacle.

19. The method as in claim 14 further including the preliminary step of
h) placing at least one contoured insert into the generally shallow enlarged rectangular receiving receptacle prior to introducing said first layer of uncured concrete into said receptacle.

20. The method as in claim 14 further including the intermediate step of
i) allowing a predetermined number of successive layers to be introduced into the generally shallow enlarged rectangular receiving receptacle;
j) placing at least one contoured insert upon the top layer of the introduced layers; and,
k) introducing the remainder of said successive layers into said receiving receptacle.

21. The method as in claim 15 further including the preliminary step of
h) placing at least one contoured insert into the generally shallow enlarged rectangular receiving receptacle prior to introducing said first layer of uncured concrete into said receiving receptacle.

22. The method as in claim 15 further including the intermediate step of
i) allowing a predetermined number of successive layers to be introduced into the generally shallow enlarged rectangular receiving receptacle;
j) placing at least one contoured insert upon the top layer of the introduced layers; and,
k) introducing the remainder of said successive layers into said receiving receptacle.

23. The method as in claim 16 further including the preliminary step of
h) placing at least one contoured insert into the generally shallow enlarged rectangular receiving receptacle prior to introducing said first layer of uncured concrete into said receiving receptacle.

24. The method as in claim 16 further including the intermediate step of
i) allowing a predetermined number of successive layers to be introduced into the generally shallow enlarged rectangular receiving receptacle;
j) placing at least one contoured insert upon the top layer of the introduced layers; and,
k) introducing the remainder of said successive layers into said receiving receptacle.

25. The method as in claim 9 further including the intermediate step of
i) allowing a predetermined number of successive layers to be introduced into the generally shallow enlarged rectangular receiving receptacle;
j) placing at least one contoured insert upon the top layer of the introduced layers; and,
k) introducing the remainder of said successive layers into said receiving receptacle.
